(19) United States
(12) Patent Application Publication
(10) Pub. No.: US 2019/0370034 A1
(43) Pub. Date: Dec. 5, 2019

(54) REMOTE APPLICATION ACCESS IN A VIRTUAL DESKTOP INFRASTRUCTURE ENVIRONMENT

(71) Applicant: FSLOGIX, INC., Suwanee, GA (US)

(72) Inventor: Kevin GOODMAN, Alpharetta, GA (US)

(21) Appl. No.: 16/426,753

(22) Filed: May 30, 2019

Related U.S. Application Data
(60) Provisional application No. 62/680,870, filed on Jun. 5, 2018.

(51) Int. Cl. G06F 9/451; G06F 9/455; G06F 16/188

(52) U.S. Cl. CPC G06F 9/452; G06F 2009/45583; G06F 16/188; G06F 9/45558

(57) ABSTRACT

Technologies are disclosed for providing remote application access in a virtual desktop infrastructure (“VDI”) environment. Application and OS files may be encapsulated in VHDs in such a way that the files appear to an OS and applications to be stored on a local mass storage device. A filter driver may monitor registry activity, detect I/O requests or instructions directed to paths at a local computing system, and redirect the detected I/O requests or instructions to an attached VHD. This allows for a computing system to access an application encapsulated within a remote VHD as if the application was stored locally. In this way, the computing device may access and use applications in a virtual computing environment without the need to package/sequence the applications.

### CROSS-REFERENCE TO RELATED APPLICATIONS

This application claims priority under 35 U.S.C. § 119(e) to U.S. Provisional Patent Application No. 62/680,870, which was filed on Jun. 5, 2018 and titled “SYSTEMS AND METHODS FOR REMOTE APPLICATION ACCESS IN A VIRTUAL DESKTOP INFRASTRUCTURE,” the entire disclosure of which is expressly incorporated by reference herein in its entirety.

### BACKGROUND

Virtual desktop infrastructure (“VDI”) is virtualization technology that hosts a desktop operating system on a centralized server in a data center. Many technical benefits can be realized through implementations of VDI, including the ability to use “thin” client devices, improved security, and efficient management of applications and devices. The shift from device-local computing environments to “virtual” computing environments such as VDI has, however, created other technical problems. For example, many applications were not originally designed to be used in a virtual environment such as VDI, but rather were designed to reside locally on a user's computer.

Technologies exist that enable applications to be streamed in real-time to client devices from a virtual application server, thereby eliminating the need for traditional local installation of applications. In order to utilize these technologies, however, applications must by converted into virtual packages for deployment to client devices. This process is sometimes referred to as “sequencing” or “packaging.” Once an application has been sequenced, it can be streamed to a client computing device, as it runs in its own self-contained virtual environment.

Sequencing of applications is not, however, without its own technical drawbacks. In particular, application sequencing is a brute force method that is not always effective. The time required to sequence an individual application may range anywhere from a few minutes to several days. As a result, sequencing of applications can consume significant computing resources, particularly when many applications are sequenced, such as for organizations that utilize hundreds or even thousands of applications. For these organizations, and many others, application sequencing is not a realistic option for application virtualization.

It is with respect to these and other technical challenges that the disclosure made herein is presented.

### SUMMARY

Technologies are disclosed for providing remote application access in a VDI environment. Through implementations of the disclosed technologies, applications can be provided to client devices in a VDI environment in a manner that does not require sequencing. As a result, significant computing resources can be conserved as compared to solutions that require sequencing of applications. Other technical benefits not specifically mentioned herein can also be realized through implementations of the disclosed subject matter.

The disclosed technologies generally relate to improving computer systems by optimizing application deployment and application use in VDIs and, more particularly, to leveraging virtual hard drives (“VHDs”) for providing a remote access location for applications in VDI environments. According to various aspects of the present disclosure, VHDs are used as containers for storing application files (e.g., .DLL files, .EXE files, etc.) or bootable OS images including the application files for allowing a computing device to utilize an application without prior packaging/sequencing of the application.

Application and OS files may be encapsulated in VHDs in such a way that the files appear to an OS and applications to be stored on a local mass storage device. In various embodiments, a filter driver service monitors registry activity, detects I/O requests or instructions directed to paths in the local computing system, and redirects the detected I/O requests or instructions to an attached VHD storing the encapsulated files.

As will be discussed in greater detail herein, application files may be encapsulated in the VHDs. Attaching a particular VHD to a computing system configured in the manner disclosed herein allows for the computing system to access an application encapsulated within the VHD as if the application was stored locally. In this way, the computing system may access and use applications in a virtual computing environment without the need to package/sequence the applications.

These and other embodiments, features, and benefits of the claimed invention(s) will become apparent from the following detailed written description of the preferred embodiments and embodiments taken in conjunction point with the following drawings, although variations and modifications thereto may be affected without departing from the spirit and scope of the novel concepts of the disclosure.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a software architecture diagram illustrating aspects of the configuration and operation of a computing system configured to implement the technologies disclosed herein, according to one embodiment of the present disclosure;

FIG. 2 is a flow diagram showing a routine that illustrates aspects of an exemplary system process, according to one embodiment of the present disclosure;

FIG. 3 is a flow diagram showing a routine that illustrates aspects of an exemplary service setup process, according to one embodiment of the present disclosure;

FIG. 4 is a flow diagram showing a routine that illustrates aspects of an exemplary user logon process, according to one embodiment of the present disclosure;

FIG. 5 is a flow diagram showing a routine that illustrates aspects of an exemplary user configuration process, according to one embodiment of the present disclosure;

FIG. 6A is a computing architecture diagram illustrating additional aspects of the configuration and operation of a computing system configured to implement the technologies disclosed herein, according to one embodiment of the present disclosure;

FIG. 6B is a computing architecture diagram illustrating additional aspects of the configuration and operation of a computing system configured to implement the technologies disclosed herein, according to one embodiment of the present disclosure;

FIG. 7 is a flow diagram showing a routine that illustrates aspects of a VHD attachment process, according to one embodiment of the present disclosure;

FIG. 8 is a flow diagram showing a routine that illustrates aspects of another VHD attachment process, according to one embodiment of the present disclosure;

FIG. 9 is a flow diagram showing a routine that illustrates aspects of a redirection process, according to one embodiment of the present disclosure;

FIG. 10 is a flow diagram showing a routine that illustrates aspects of a process for encapsulating an operating system image within a VHD, according to one embodiment of the present disclosure;

FIG. 11 is a flow diagram showing a routine that illustrates aspects of an exemplary user logoff process, according to one embodiment of the present disclosure;

FIG. 12 is a computing architecture diagram showing one illustrative configuration for a computing device configured to implement the technologies disclosed herein, according to one embodiment of the present disclosure; and

FIG. 13 is a network diagram showing one illustrative configuration for a network environment in which the technologies disclosed herein can be implemented, according to one embodiment of the present disclosure.

### DETAILED DESCRIPTION

The following detailed description is directed to technologies for providing remote application access in a VDI environment. As discussed briefly above, implementations of the disclosed technologies can reduce the utilization of computing resources when providing applications in a VDI environment. Implementations of the disclosed technologies can also improve network performance by reducing the amount of network traffic required to provide an application to a computing device in a virtual computing environment. Other technical benefits not specifically mentioned herein can also be realized through implementations of the disclosed subject matter.

While the subject matter described herein is presented in the general context of a computing system executing a MICROSOFT WINDOWS NT-based operating system, those skilled in the art will recognize that other implementations can be performed in combination with other types of operating systems and computing systems. Those skilled in the art will also appreciate that the subject matter described herein can be practiced with other computer system configurations, including hand-held devices, multiprocessor systems, microprocessor-based or programmable consumer electronics, computing or processing systems embedded in devices (such as wearable computing devices, automobiles, home automation etc.), minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., aspects of a computing system configured for providing remote application access in a VDI environment will be described.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

Overview

Embodiments of the present disclosure generally relate to the provision of remote application access in a VDI environment. More particularly, the disclosed technologies relate to improving computer systems by optimizing application deployment and application use in VDI environments. Other technical benefits might also be realized through implementations of the disclosed technologies.

Through implementations of the disclosed technologies, virtual hard drives (“VHDs”) can be leveraged to provide a remote access location for applications in VDI environments. In particular, VHDs can be used as containers for storing application files (e.g., .DLL files, .EXE files, etc.) or bootable operating system (“OS”) images that include application files for enabling an application to be utilized in a VDI environment without prior sequencing.

In some embodiments, bootable OS images are utilized that include reduced or “stripped” registries where unnecessary or non-essential files are removed. These OS images are substantially smaller in size than a typical OS image due to the removal of unnecessary or non-essential files (e.g., printer drivers, user documents and settings, other program files, etc.).

In order to provide the functionality disclosed herein, an application can be encapsulated in a VHD in such a way that the application appears to an OS and applications on a client device to be residing locally (e.g. on a local mass storage device). In various embodiments, a filter driver or filter driver service may monitor registry activity to detect I/O requests or instructions directed to registry paths in a computing system associated with an encapsulated application. The filter driver or filter driver service might then redirect the I/O requests or instructions to an attached VHD storing an encapsulated application or application files.

As will be discussed in greater detail herein, application files may be encapsulated in VHDs attached to a computing system in a manner that allows the computing system to access the application (or only the particular application files needed at a given time) as if the application was stored and running locally at the computing system. In this way, a computing system may access and use applications in a virtual computing environment without the need to sequence the applications.

According to particular embodiments, the technologies disclosed herein include a service that runs on a computing device that makes changes to the computing device in order to direct OS requests to remote files, as opposed to local files or shares. For example, a large file, such as a MICROSOFT OUTLOOK data file may be encapsulated in a VHD. A service running on a computing device may be configured to modify the MICROSOFT OUTLOOK data file default folder such that the OS is directed to access the encapsulated MICROSOFT OUTLOOK data file on the remotely-located VHD instead. In another example, a service running on a computing device might be configured to modify an ADOBE® data file default folder on the computing device, such that the OS running on the computing device is directed to access encapsulated application files on an attached VHD rather than accessing files that are typically stored in the local ADOBE® data file.

In particular embodiments, the service disclosed herein, for example, might rename the existing folder “C:\users\<username>\AppData\Local\Microsoft\Outlook” on a computing device to “C:\users\<username>\AppData\Local\Microsoft\Outlook.hold”. The service then, in this embodiment, creates a junction point at C:\users\<username>\AppData\Local\Microsoft\Outlook that points to the VHD storing the encapsulated MICROSOFT OUTLOOK data file. In this way, when the OS executing on the computing device searches for C:\users\<username>\AppData\Local\Microsoft\Outlook, it is redirected to the MICROSOFT OUTLOOK data file in the remotely-located VHD and the original data located at C:\users\<username>\AppData\Local\Microsoft\Outlook is now “hidden” from the OS at C:\users\<username>\Appdata\Local\Microsoft\Outlook.hold. In certain embodiments, a VHD including encapsulated application files may be attached as a letter drive (e.g., C:\ drive, F:\ drive, T:\ drive, etc.), and the service may be configured to access files from the registries in the attached VHD rather than from the local registries.

In certain embodiments, the service running on the computing device may be configured to access (e.g., transmit to, read from, etc.) data files on one or more VHDs. Continuing with the example above referencing particular data paths on a local hard drive, the service may be configured to create a junction point at a particular data path that points to the location of a VHD (a “VHD location”) that includes an encapsulated file, thereby allowing I/O requests (e.g. read requests and write requests) generated at the computing device that are initially directed to a local path or directory to be redirected to the junction point-defined VHD location.

Generally, the junction point makes the VHD appear to applications as if it is located at the original file path of the original file/folder. Thus, the files/folders encapsulated on the VHD appear to be the original file(s)/folder(s) located local to the computing device and applications that modify their behavior based upon whether a file is remote or local will operate as if the original file were still present locally.

According to various aspects of the present disclosure, references or pointers to additional VHD locations may be persisted in a configuration file accessible by the service, persisted in a service registry, etc. In one embodiment, requests directed to a local path (e.g., a memory address in a local cache) may trigger the service to redirect the request to the VHD location configured via the junction point, as well as any additionally persisted VHD locations. Various aspects of the above process will be discussed in further detail below. Prior to discussing exemplary processes, an exemplary operating environment for implementing the technologies disclosed herein will be described.

Exemplary Architecture

As discussed herein, the disclosed technologies relate to encapsulation of an application or application files in such a way that the application or application files appear to the local OS and any local applications to be residing locally. In particular embodiments, a service is implemented within an OS environment to perform aspects of the disclosed functionality. In some embodiments, the service intercepts requests, such as Input/Output (“I/O”) requests or registry requests, evaluates rules based on the intercepted requests during runtime, and/or performs actions based on the rule evaluations, such as passing requests through, redirecting requests, modifying requests, hiding resources, or performing other actions. A registry is a collection of configuration settings for software programs, hardware devices, user preferences, operating system configurations, etc.

The disclosed service might be implemented in one or more of a computing device's file system filter drivers and registry filter drivers as a terminal configuration management service. In some embodiments, the terminal configuration management service is implemented as, or is configured with the functionality of, a file system filter driver and a registry filter driver (which might be referred to herein as a file and registry filter driver (or simply a “filter driver”).

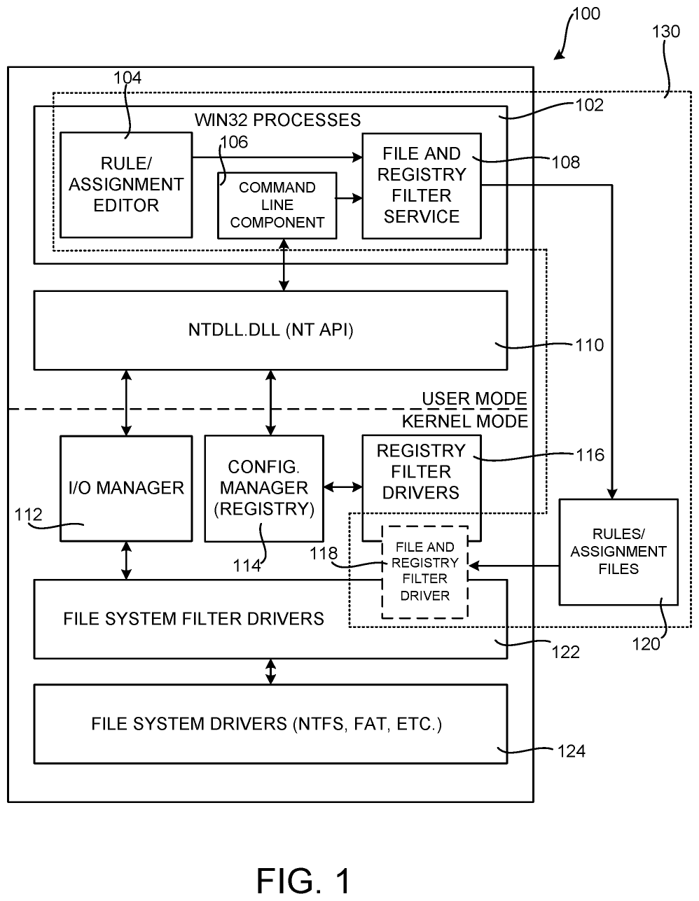

FIG. 1 is a simplified block diagram of an embodiment of a typical WINDOWS NT-based OS structure 100, including Win32 processes 102 (rule/assignment editor 104, command line component 106, and file and registry filter service 108, which are described below), an NTDLL.DLL 110, an I/O manager 112, a configuration manager (registry) 114, registry filter drivers 116, file system filter drivers 122, and file system drivers 124. Win32 processes 102 are the applications and services that are running on a computing device executing the WINDOWS OS.

Win32 processes initiate calls to the file system filter drivers 122 (which interact with the underlying file system) and the configuration manager 114 by calling Win32 application programming interfaces (“APIs”) (not shown), such as CreateFile, RegOpenKey, etc. The Win32 API layer in turn calls corresponding user mode NT APIs (not shown) in the NTDLL.DLL 110, which provides the native WINDOWS NT API set. For example, NTDLL.DLL 110 includes user mode WINDOWS NT APIs like NtCreateFile, NtOpenKey, etc. User mode NT APIs typically match up one-to-one with a kernel mode API. For example, NtCreateFile maps to the ZwCreateFile API.

In some embodiments, a rule/assignment editor tool 104, which may be implemented as a program module, plug-in, script, or other type of Win32 process, may be provided to facilitate the creation and modification of rules and assignments. The rule/assignment editor tool 104 may, in some embodiments, be a graphical user interface (“GUI”)-based tool. Alternatively, or additionally, a command line component 106, can be provided for creating and adding rules/assignments, deleting rules/assignments, triggering reloads of rules/assignments files 120 by the filter driver 118, etc. These components may be provided on the computing device where the filter driver 118 is executed and/or may be provided on an administrator computing device such that the rules/assignments files 120 can be distributed to any number of computing devices.

A file and registry filter service 108 might also be provided to operate in conjunction with the filter driver 118. The file and registry filter service 108 might be implemented as an executable or other type of program module. This service may be configured to accept commands from the command line component 106 and/or the rule/assignment editor tool 104, compile rules/assignments files 120 from user format to driver format, watch for updates to rules/assignments file(s) 120 appear, and notify the filter driver 118 when such updates are detected.

The file and registry filter service 108 may be provided on the computing device where the filter driver 118 is executed and/or on an administrator computing device. For example, the file and registry filter service 108 may determine that new rules/assignments files 120 have been created, compile those files and store them in a folder or other location accessible to the filter driver 118. The file and registry filter service 108 may then notify the filter driver 118 that there are new rules/assignments files 120 to process.

In various embodiments, the I/O manager 112 takes the parameters passed to a particular function and creates a corresponding Interrupt Request Packet (“IRP”). An IRP is a memory structure that contains information about a request that will be passed to lower level components within an OS storage stack. In some embodiments, file system filter drivers (“FSFDs”) 122 are kernel components that are loaded and inserted into the communication path between the I/O manager 112 and the file system drivers 124. FSFDs 122 “intercept” I/O requests within the OS prior to processing by the file system drivers 124.

FSFDs 122 are kernel-mode drivers that add value to or modify the behavior of a file system. A FSFD 122 can filter I/O operations for one or more file systems or file system volumes. Depending on the nature of the FSFD 122, filter can mean log, observe, modify, or even prevent. Typical applications for FSFDs 122 include, but are not limited to, antivirus utilities, encryption programs, and hierarchical storage management systems.

FSFDs 122 can be implemented in a stack each having a configurable priority. In some configurations (e.g., in WINDOWS 7 and later versions of WINDOWS NT-based OSs), a FSFD 122 is implemented as a filter manager that provides for the creation and management of “mini-filter drivers,” which can perform functions such as antivirus, undelete, backup, virtualization, activity monitoring, or other functions.

According to some embodiments, the configuration manager 114 implements a registry, handles all registry API calls, and stores the registry information in multiple database files. In at least one embodiment, the configuration manager 114 provides a filtering interface that allows for the implementation of registry filter drivers 116. Registry filter drivers 116 can be implemented as kernel components that register with the configuration manager 114 to intercept, handle, and possibly modify registry calls. Registry filter drivers 116 can thus be configured as registry I/O handlers.

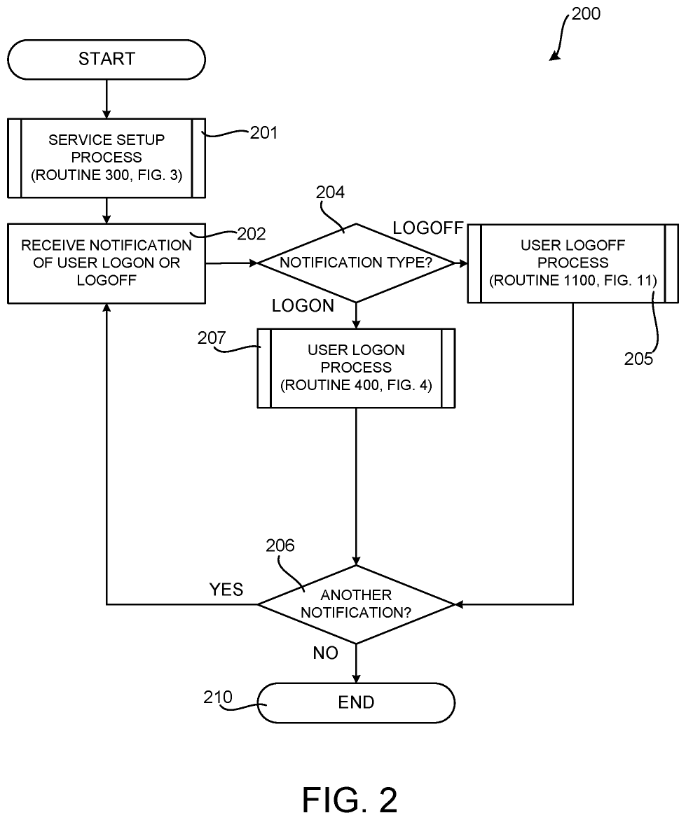

In the embodiment shown in FIG. 1, the filter driver 118 is configured to perform the functionality described below with respect to FIGS. 2-11 and elsewhere herein and is implemented within the FSFD 122 stack and the registry filter driver 116 stack. For example, portions of the filter driver 118 may be implemented as a FSFD 122 (or a mini-filter driver) and portions may be implemented as a registry filter driver 116. Other implementations of the filter driver 118 will also be apparent to those of skill in the art. Thus, I/O requests handled by the I/O manager 112 and registry I/O requests handled by the configuration manager 114 can be intercepted and handled by the filter driver 118.

In various embodiments, which will be described in more detail below, the functionality provided by the filter driver 118 allows the presence of a directory, file, registry key, registry value or other resource (e.g., a MICROSOFT OUTLOOK data file) to be hidden from view. These objects may remain stored upon a local storage device but are hidden from users.

In some embodiments, the filter driver 118 creates a junction point that redirects OS requests to a new directory, file, or resource (e.g. a VHD). In further embodiments, the filter driver 118 attaches to or detaches from one or more VHDs. As discussed above, the junction point makes the VHD appear to applications as if it is located at the original file path of the original file/folder. Thus, the files/folders encapsulated on the VHD appear to be the original file(s)/folder(s) located local to the computing device and applications that modify their behavior based upon whether a file is remote or local will operate as if the original file were still present locally.

The filter driver 118 can be configured to hide different resources or types of resources for different users, for example based on access authorization credentials or other criteria assigned to or associated with a user or group of users. For example, different sets of resources may be hidden for different users or different groups of users, who each may therefore have a significantly different view of the files stored at the same computing device.

In some embodiments, the filter driver 118 may be configured to hide different resources or types of resources for or during different processes, threads, sessions, etc. In some embodiments, the filter driver 118 may be configured to start or stop hiding certain resources, change file names, and/or attach/detach VHDs based on trigger events such as schedule, location of the user and/or computing device, network access, etc.

The operations to be performed by the filter driver 118 may be specified by way of one or more rules/assignments files 120. For example, an administrator can create a rule that specifies one or more objects to be hidden or changed (file, directory, key, or value) and any applicable conditions or trigger events. The administrator may then assign the rule to one or more specific user or groups of users. In some embodiments, rules may be stored in one file and corresponding assignments may be stored in another associated file. In other embodiments, rules and corresponding assignments may be stored in the same file. Other mechanisms for implementing rules and assignments will be apparent to those skilled in the art and are deemed to be within the scope of this disclosure.

Exemplary Processes

The following is a description of exemplary processes that may be executed by a computing device implementing the architectural components discussed above. As will be understood from the disclosure presented herein, the rule/assignment editor 104, command line component 106, file and registry filter service 108, rules/assignment files 120, and filter driver 118 may operate together or alone to complete some or all of the operations discussed below. Therefore, for simplicity and brevity, but not for the purpose of limitation, these components will collectively be referred to below as the “service 130.”

FIG. 2 is a flow diagram showing a routine 200 that illustrates aspects of an exemplary, high-level overview of the operation of the disclosed technologies, according to one embodiment disclosed herein. In particular, the routine 200 illustrates aspects of a process by which the service 130 presents a VHD to a software program or OS such that the VHD appears to be local to the computing device on which the software program or OS is executing. By exposing the VHD in this manner, the computing device or a software program operating on the same may access a file and/or folder encapsulated in the VHD. Thus, in various embodiments, the service 130 is able to permit remote access to files that usually must be locally stored for proper operation.

For example, the service 130 may replace a MICROSOFT OUTLOOK data file that usually must be kept locally with a data file located on a remote VHD so that MICROSOFT OUTLOOK may operate more efficiently. In order to provide this functionality, the service 130 can change the file path of the original file/folder at operation so that the software program that uses that original file/folder can no longer access it at its original location. In this way, the original file/folder is essentially “hidden” from the software program/OS/user but has not been deleted.

The service 130 then creates a junction point that redirects requests generated by the OS or software program to the VHD. Generally, the junction point makes the VHD appear to applications as if it is located at the original file path of the original file/folder. Thus, the files/folders encapsulated on the VHD appear to be the original file(s)/folder(s) located local to the computing device and applications that modify their behavior based upon whether a file is remote or local will operate as if the original file were still present locally.

It should be appreciated that the logical operations described herein with regard to FIG. 2, and the other FIGS., can be implemented (1) as a sequence of computer implemented acts or program modules running on a computing device and/or (2) as interconnected machine logic circuits or circuit modules within a computing device. The particular implementation of the technologies disclosed herein is a matter of choice dependent on the performance and other requirements of the computing device.

Accordingly, the logical operations described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein.

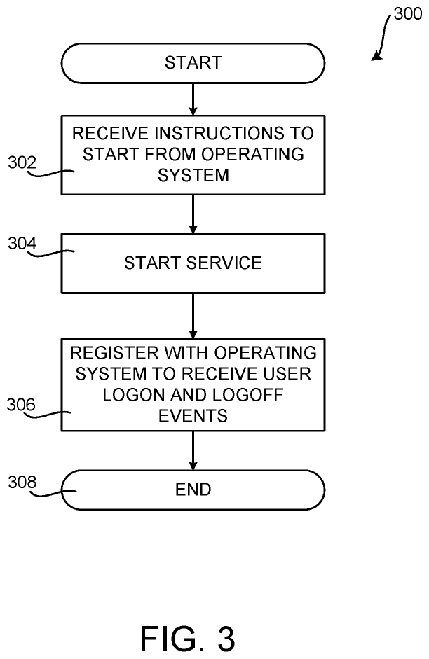

The routine 200 begins at operation 202, where a service setup process is performed, wherein the service 130 is started by the OS (e.g., when the OS starts after a computing device is turned on) and registers with the OS to receive notifications of user logon and logoff activity. After registering with the OS, the service 130, in one embodiment, executes in the background of the OS until the computing device is turned off. Details regarding one illustrative service setup process will be provided below with regard to FIG. 3.

At operation 202, in various embodiments, the service 130 receives a notification of user logon or logoff activity from the OS. Generally, this notification corresponds to either a user logging on to use the OS (e.g., after turning on the computing device) or logging off after using the OS (e.g., before turning off the computing device). Thus, in one embodiment, the service 130 determines, at operation 204, whether the notification is of a user logon or logoff (e.g., based on the header of the notification, the structure of the notification, etc.).

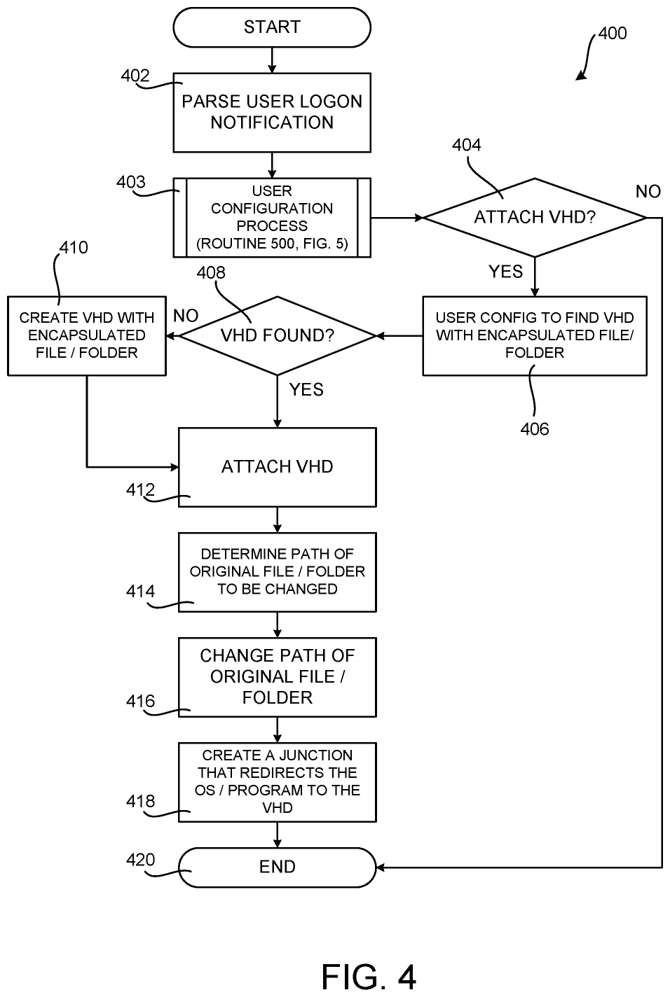

If the notification is of a user logon, then, in one embodiment, the service 130 proceeds to operation 207, where a user logon process is performed. In various embodiments, the service 130 determines the appropriate VHD to attach to the computing device and makes the appropriate changes to the file paths of any original files/folders that the VHD is replacing during the user logon process. Details regarding one illustrative user logon process are provided below with regard to FIG. 4.

If the notification received at operation 202 is of a user logoff then, in one embodiment, the routine 200 proceeds to operation 205, where a user logoff routine is performed. In the user logoff routine, the VHD is detached and the junction point is removed such that the files/folders are restored to their original file paths.

In various embodiments, the service 130 determines, at operation 206, whether to wait for another notification based on one or more predefined rules. If the service 130 determines, at operation 206, to wait for another notification, then the service 130 returns to operation 202, waits for another notification, and processes the notification in the manner described above

The service 130 may wait for another notification because the previously-received notification was of a user logon and, thus, a user logoff notification will be forthcoming or because the user has logged off of the OS but not turned off the computing device. If, however, the service 130 determines, at operation 206, not to wait for another notification (e.g., the computing device is being shut down, etc.), then the exemplary routine 200 proceeds to operation 210, where it ends.

Referring to FIG. 3, a routine 300 illustrating aspects of an exemplary service setup process will be described. The routine 300 begins at operation 302 when an OS provides instructions to the service 130 to start. The routine 300 then proceeds from operation 302 to operation 304, where the service 130 starts upon receiving a specific instruction from the OS. In some embodiments, operation 302 is optional and the service 130 starts automatically, at operation 304, upon startup of the OS.

Generally, in various embodiments, the service 130 executes as a background process, or processes. After starting, in various embodiments, the service 130 registers, at operation 306, with the OS to receive notifications of user logon and logoff events. The routine 300 then proceeds from operation 306 to operation 308, where it ends. As will be apparent to one having ordinary skill in the art, this registration permits the service 130 to know when to take certain actions (e.g., initiate processes, attach/detach VHD, etc.).

Referring now to FIG. 4, a routine 400 will be described that illustrates aspects of an exemplary user logon process. Generally, the user logon process is a process by which the service 130 identifies the appropriate VHD to attach to the computing device and makes the appropriate changes to the file paths of any original files/folders that the VHD is replacing. For example, the service 130 may encapsulate MICROSOFT OUTLOOK data files within a VHD and redirect OS requests from the location of a locally-stored MICROSOFT OUTLOOK data file to the remotely-located encapsulated files. Once redirected, the MICROSOFT OUTLOOK software program can access the files within the VHD as if they were local to the computing device on which the service 130 is executing. In particular embodiments, the service may encapsulate ADOBE® application files, or an OS image stripped to include only the files necessary for running an ADOBE® application (or any other suitable application), within a VHD.

The routine 400 begins, in various embodiments, at operation 402, wherein the service 130 parses a user logon notification to retrieve a user identification corresponding to the user that is currently logged in to the OS. Generally, the service 130 may extract other data from the logon notification at operation 402 as appropriate (e.g., time and date information for analytics purposes, the network address of the computing device for security purposes, etc.).

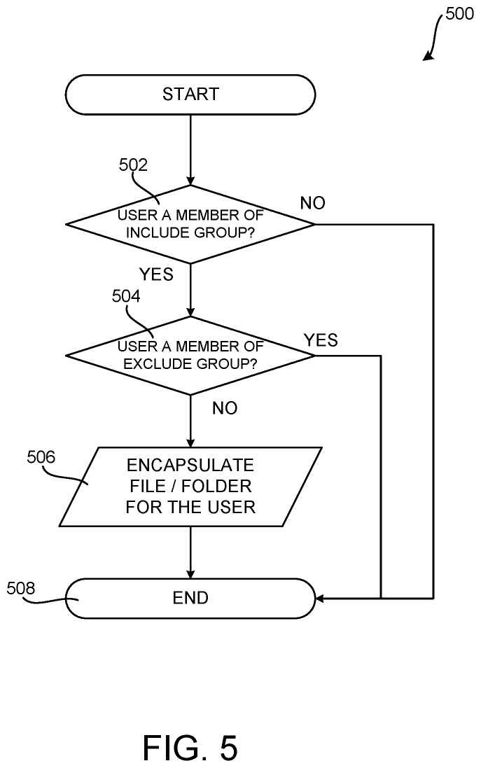

From operation 402, the routine 400 proceeds to operation 404, where the service 130 may use the data extracted/parsed from the user logon notification to determine whether to encapsulate a particular file for the user in a VHD. Additional details regarding this process will be provided below with regard to FIG. 5.

From operation 403, the routine 400 proceeds to operation 404, where the service 130 determines whether to attach a VHD, in one embodiment, based on the results of the user configuration routine described below with regard to FIG. 5. If the service 130 determines, at operation 404, not to attach a VHD, then the routine 400 proceeds from operation 404 to operation 420, where it ends.

If, however, the service 130 determines, at operation 404, to attach a VHD, then the routine 400 proceeds from operation 404 to operation 406. At operation 406, in one embodiment, the service 130 searches for the appropriate VHD (with the correct encapsulated file/folder) for the user, based on the results of the user configuration routine described below with regard to FIG. 5.

In one embodiment, a user is associated with a particular configuration that identifies the file(s)/folder(s) that will be encapsulated on VHDs. In some embodiments, the service 130 uses a lookup table to determine which VHD is associated with a particular user. Accordingly, at operation 408, the service 130 determines, in one embodiment, whether the appropriate VHD was found (at operation 406).

If the service 130 determines at operation 408 that the appropriate VHD was not found then, in one embodiment, the routine 400 proceeds from operation 408 to operation 410, where the service 130 creates a VHD with the appropriate encapsulated file/folder. For example, the service 130 may create a VHD if the user logging on to the OS has never logged on previously, or if the user deleted a previously created VHD.

Generally, once attached, the VHD appears to the computing device like any other attached file system (e.g., thumb drive, etc.) so the file/folder is stored within this file system, as part of operation 410, according to methods known in the art to store files within a file system. Generally, after creating the VHD at operation 410 or if the service 130 determines, at operation 408, that the appropriate VHD was found (at operation 406), then, in various embodiments, the routine 400 proceeds to operation 412, where the service 130 attaches the VHD to the computing device. As will be understood, this disclosure places no limitations on the type of VHD, file/folders encapsulated within the VHD, OS, computing device, or method of attaching the VHD to the OS/computing device. By attaching the VHD, the computing device may now access the files/folder encapsulated within the same.

In one embodiment, the service 130 uses APIs provided by the OS to attach the VHD at operation 412. For example, when executing on the WINDOWS OS, the service 130 may use the following APIs: OpenVirtualDisk, CreateVirtualDisk, AttachVirtualDisk, and DetachVirtualDisk. These APIs are merely illustrative, however, and other APIs can be utilized in other configurations.

From operation 412, the routine 400 proceeds to operation 414, where the service 130 determines the file path of the original file/folder that is to be redirected to file(s)/folder(s) encapsulated within the VHD attached at operation 412. The service 130 then changes the file path of the original file/folder at operation 416 so that the software program that uses that original file/folder can no longer access it. In this way, the original file/folder is essentially “hidden” from the software program/OS/user but has not been deleted, so it could still be used if its location was known (e.g., by renaming the path by adding a “.hold” or other method).

In various embodiments, at operation 418, the service 130 creates a junction point that redirects requests generated by the OS or software program to the VHD. Generally, the junction point makes the VHD appear as if it is located at the original file path of the original file/folder determined at operation 414. Thus, the files/folders encapsulated on the VHD appear to be the original file(s)/folder(s) located local to the computing device. Consequently, applications that modify their behavior based upon whether a file is remote or local will operate as if the original file were still present locally.

Referring now to FIG. 5, a routine 500 will be described that illustrates aspects of an exemplary user configuration process. The exemplary user configuration process is a process by which the service 130 determines whether to encapsulate a file/folder for a user that has just logged on to the OS.

The routine 500 begins at operation 502, where the service 130 determines whether the current user is a member of an “include” group that specifies users for which requests are to be redirected to VHDs in the manner described herein. If the user is not a member of the include group, the routine 500 proceeds from operation 502 to operation 508, where it ends. If, however, the user is a member of the include group, then the service 130 determines whether the user is a member of the “exclude” group at operation 504. The exclude group identifies users for which requests are not to be redirected to VHDs in the manner described herein.

If the user is a member of the exclude group, the routine 500 proceeds from operation 504 to operation 508, where it ends. For example, an administrator may have included “all users” in the include group but decided that certain specific users should be in the exclude group (instead of trying to individually select all users except the board members to initially populate the include group).

If the user is not a member of the exclude group, then the service 130 determines, at operation 506, whether to encapsulate a file/folder for this user according to one or more predefined rules. The routine 500 then proceeds from operation 506 to operation 508, where it ends.

In one embodiment, not shown in FIG. 5, the service 130 also generates, at operation 506, a configuration that designates the particular file(s)/folder(s) to be encapsulated on the particular VHD (used by the service 130 at operation 406 in FIG. 4).

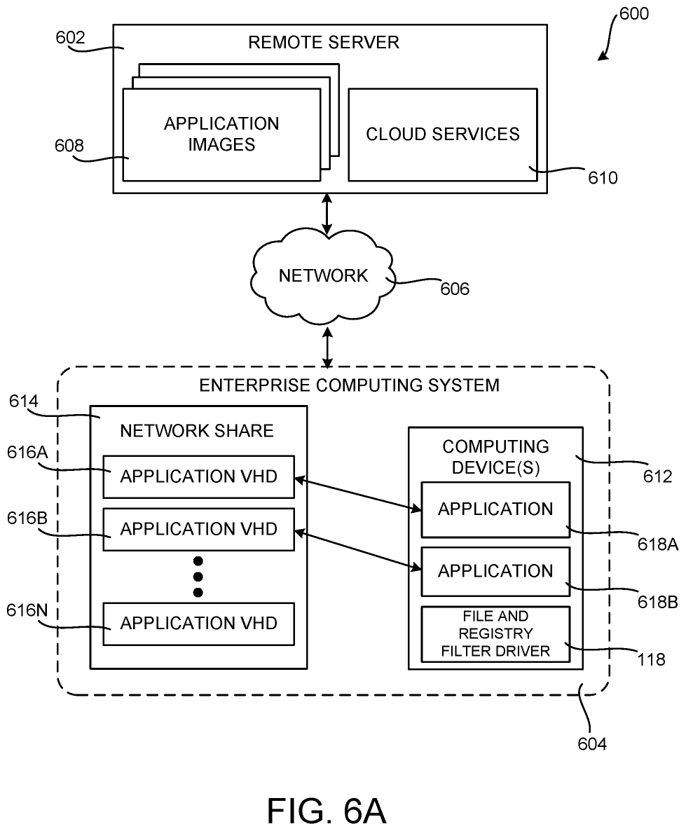

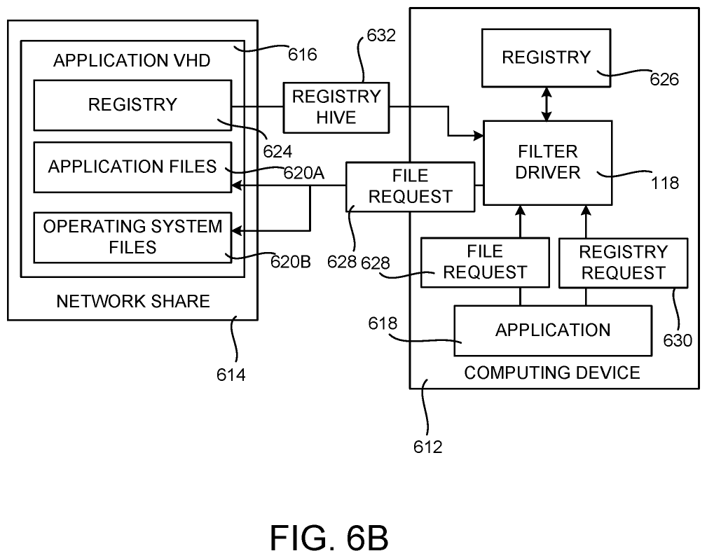

Referring now to FIG. 6A, an exemplary remote application access diagram is shown, according to one embodiment of the present disclosure. In various embodiments, the remote access diagram illustrates a computing environment 600 including at least a remote server 602 and an enterprise computing system 604, where the remote server 602 and enterprise computing system 604 are operatively connected over a network 606 (e.g., internet, LAN, WLAN, etc.).

In one embodiment, the remote server 602 may be a third-party server such as an OUTLOOK® server, an application server, or another server operable to transmit data to the enterprise computing system 604. In the present embodiment, the remote server 602 includes one or more application images 608 as well as cloud services 610. The application images 608 and cloud service 610 may be accessible by the enterprise computing system 604 via the network 606. In particular embodiments, the enterprise computing system 604 includes one or more computing devices 612 configured to support one or more types of operating systems. In the present embodiment, the enterprise computing system 604 includes a computing device 612 configured with a WINDOWS NT OS architecture, similar to the architecture discussed above with regard to FIG. 1.

According to various aspects of the present disclosure, a computing device 612 at the enterprise computing system 604 may be a client or end-user device in a virtual computing environment. The computing device 612 may rely on the remote server 602 as a host, particularly for providing virtual applications via the application images 608. In certain embodiments, the computing device 612 might also rely on the remote server 602 for data from the cloud services 610 for building the virtual computing environment within the enterprise computing system 604.

In certain embodiments where the computing device 612 relies on the remote server 602 as a host for virtual applications, the computing device 612 may request one or more of the application images 608 from the remote system 602. According to various aspects of the present disclosure, and as will be described in greater detail herein, the one or more application images 608 from the remote system 602 may provide a template for application registry files to be encapsulated in a VHD, such as the VHDs 616A-616N.

As described in greater detail below, VHDs 616A-616N may be attached to the computing device 612 such that the OS executing on the computing device 612 interacts with the encapsulated application files in the attached VHDs 616A-616N (which might be referred to herein as “application VHDs”) as if they resided locally at the computing device 612. Furthermore, a junction may be created at a local directory or file path on the computing device 612 that points to these encapsulated application files in the VHDs 616A-616N such that the computing device 612 operating system may continue to reference these encapsulated application files as if they were locally stored.

In some embodiments, the filter deriver 118 may be configured to redirect registry requests for application files to the attached VHDs 616A-616N without a junction created at a local directory, such that the filter driver 118 may be configured to automatically direct all registry requests generated by a particular application, or applications, to the letter drive, for example, of an attached VHD 616.

As shown in FIG. 6A, the enterprise computing system 604 includes a network share 614. In particular embodiments, the network share 614 may store the application VHDs 616A-616N, that include the encapsulated application files from the application images 608. In various embodiments, the application VHDs 616A-616N may each include encapsulated application files (e.g., an application registry hive) associated with a particular application. For example, the application VHD 616A may include encapsulated MICROSOFT® WORD® files, and the application VHD 616B may include encapsulated ABODE® files. In some embodiments, the network share 614 may include as many application VHDs as necessary, indicated by the application VHD 616N, to accommodate each system application that is to be delivered to the computing device 612 virtually.

In a particular embodiment, the computing device 612 may attach or mount the application VHDs 616A-616N such that the application VHDs 616A-616N appear and operate as if they resided locally. As shown the FIG. 6A, and for illustrative purposes only, the computing device 612 includes an application 618A and an application 618B. In one embodiment, the computing device may also include the filter driver 118 and associated services.

According to various aspects of the present disclosure, the filter driver 118 may be configured to detect application file activity, such as application calls and requests to specific application file paths (e.g., C:\ProgramFiles\Adobe\exampleFile.DLL). These application calls and requests are originally directed to a file path local to the computing device 612, however, the filter driver 118 may be configured to redirect the application calls and requests to the appropriate attached application VHD, such that the application VHD includes the resources for fulfilling the application calls and request. In this way, the computing device 612 does not need to locally store a physical copy of the application or application files, nor does it need to stream a packed and sequenced version of the application (e.g., via CITRIX® or the like). The combination of the encapsulated application files in a VHD (the application VHDs 616A-616N) attached to the computing device 612 and the filter driver 118 allows for the disclosed system to access applications as needed, in a virtual environment, without sacrificing performance or reliability.

Consider, for example, a scenario where a user operating a “light-weight” computing device 612 selects to open a word processing application on the light-weight device. Such light-weight devices typically include limited mass storage and thus do not store many applications locally. The light-weight computing device is also designed to operate in a virtual environment. One conventional method for providing applications to such light-weight devices is to provide applications via a web browser. Browser-version applications are typically lite versions of more fully featured applications and, as a result, generally may feel to a user (regarding performance and perception) like inferior applications compared to their locally executed counterparts.

Continuing with this example, the light-weight computing device may instead be configured to attach one or more application VHDs 616A-616N to the device, therefore allowing access to application files via an attached VHDs 616A-616N as if they were stored locally at the computing which, in turn, allows for the application to run on the light-weight computing device while appearing and performing as if the entire application were running local to the device. As is discussed throughout the present disclosure, the configuration of the filter driver 118 allows for registry calls and requests directed to local application files to be detected and redirected to the application files encapsulated within the attached VHDs 616A-616N.

FIG. 6B is a computing architecture diagram illustrating additional aspects of the configuration and operation of a computing system configured to implement the technologies disclosed herein, according to one embodiment. As described briefly above, a VHD 616 can be stored on a network share 614. The VHD 616 can include operating system files 620B and application files 620A. The VHD 616 also includes a registry 624 storing entries associated with an OS and an application 612.

As also discussed briefly above, the computing device 612 is configured with a filter driver 118. The filter driver 118 is configured to intercept requests 628 (“file requests”) from an application 618 for files stored locally at the computing device 612. In response thereto, the filter driver 118 can redirect the request 628 to the VHD 616. In this way, requests for locally-stored files can be satisfied from a VHD 616. The VHD 616 might be stored locally at the computing device 612 or at a network-accessible location. As discussed above, file requests 628 can be redirected by making the local path of the requested file inaccessible and installing a junction at the location of the file on the local file system that points to the location of the file on the VHD 616.

The filter driver 118 is also configured to intercept requests 630 (“registry requests”) generated by an application 618 to access a registry 626 stored at the computing device 612. In response to receiving such a request 630, the filter driver 118 can redirect the request 630 to the registry 624 stored in the VHD 624.

In some embodiments, the filter driver 118 retrieves a registry hive 632 from the VHD 614 and satisfies the request from the registry hive 632. In this way, requests to access the registry 626 can be satisfied without modification of the registry 626. The registry hive 632 can be retrieved from the VHD 624 in response to receiving the request 630 or at another time.

In some embodiments, the filter driver 118 might first try to satisfy a file request 628 from a local file system. If the requested file 629 cannot be found locally, then the filter driver 118 will redirect the file request 628 to the VHD 616. In other embodiments, the filter driver 118 might first try to satisfy a file request 628 from the VHD 616. If the requested file 620 is not found on the VHD 616, the filter driver 118 can attempt to locate the file 620 on a local file system.

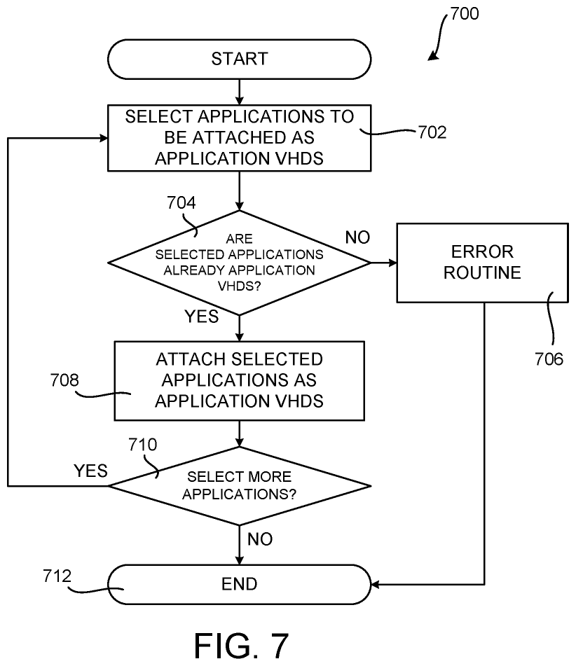

Similarly, the filter driver 118 might first try to satisfy a registry request 630 from the locally stored registry 626. If the request 630 cannot be satisfied from the registry 626, then the filter driver 118 will redirect the request 630 to the registry 624 or the registry hive 632. In other embodiments, the filter driver 118 might first try to satisfy a registry request from the registry 624 or the registry hive 632. If the request 630 cannot be satisfied from the registry 624 or the registry hive 632, the filter driver 118 will attempt to satisfy the request 630 from the locally stored registry 626. Additional details regarding these and other aspects of the disclosed technologies will be provided below with regard to FIGS. 7-11.

Turning now to FIG. 7, an exemplary routine 700 for attaching application VHDs 616A-616N to a computing device 612 will be described. Generally, when a user (or admin) launches a virtual desktop client application, or the like, he/she may configure the virtual desktop client application to include virtual applications to be attached and used during the computing session. For example, a user may configure the virtual desktop client application to include the MICROSOFT® WORD® and ADOBE® ACROBAT® applications because he/she intends to process text documents and view PDF documents.

In one embodiment, during an initial logon process (such as the exemplary routine 400 or generally whenever appropriate), a user may select one or more applications he/she would like to access during his/her computing session. As discussed above, the VDI environment disclosed herein provides the applications to the user's computing device via an attached VHD 616 including the application file(s).

In some embodiments, a “load registry hive” command executed via the remote server 602 or a computing device 612 may provide the encapsulated files needed for initiating and accessing a VHD 616. A registry hive is a logical group of keys, subkeys, and values in the registry that has a set of supporting files containing backups of its data. According to various aspects of the present disclosure, loading a registry hive may pull the application registry entries from an attached VHD 616 into memory (e.g., RAM, a letter drive, etc.) at the computing device 612.

For example, a user or admin may edit system registries by running the “regedit.exe” command in WINDOWS 7, WINDOWS 8, WINDOWS 10, or any appropriate operating system. In this example, the user may select the “load hive” command, which may prompt the user to select one or more registry hives to add to (or replace) the registry of the computing device 612. In one embodiment, the user may load the application hive to the “HKEY LOCAL MACHINE” registry, or another appropriate registry key. In certain embodiments, the disclosed system may be configured to execute these operations automatically and without user intervention (e.g., via the filter driver 118, another service discussed herein, etc.).

In particular embodiments, once the application registry hive is loaded into memory at the computing device 612, the filter driver 618 may direct registry requests (e.g. from/for the application encapsulated with the VHD 616) to the loaded application registry hive for accessing those particular application files. Additional details regarding this process will be provided below.

The routine 700 begins at operation 702 where a user selects one or more applications to be attached as application VHDs 616. In various embodiments, the computing device 612 may access the remote server 602 and search one or more available application images (e.g., application images 608). In some embodiments, and momentarily referring back to FIG. 6A, each application image 608 stored at the remote server 602 may be available to the user at the computer device 612; however, the disclosed system may be configured such that the user at the computer device 612 is assigned certain access rights that enable or disable him/her from accessing particular application images 608. In certain embodiments, the user at the computing device 612 may select one or more applications to be attached as VHDs 616 by clicking a check-box, touching an icon, or any other appropriate method for indicating his/her intent to select the application.

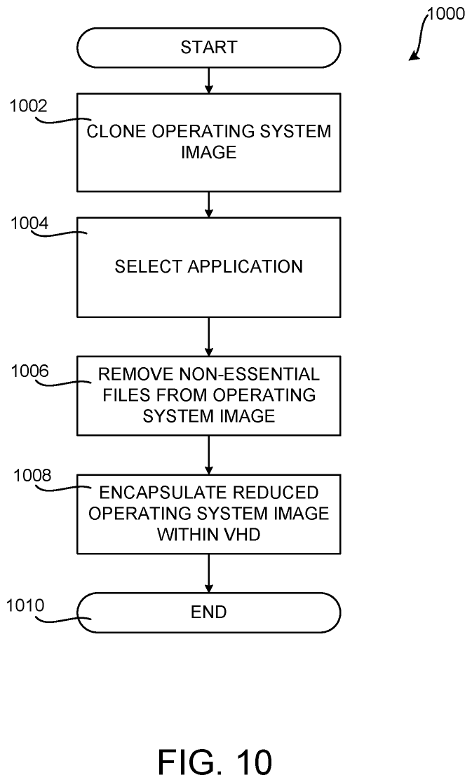

At operation 704, in one embodiment, the disclosed system may determine if the one or more selected applications are already available as attachable VHDs 616. As will be discussed in further detail below with regard to FIG. 10, applications may be encapsulated in attachable VHDs 616 if, in some embodiments, the application files were encapsulated in a bootable OS image. In certain embodiments, bootable OS images may be stripped of non-essential files to reduce the size of the OS image for performance efficiency, as well as for avoiding issues associated with packaging/sequencing and cross-application conflicts.

According to various aspects of the present disclosure, if a selected application is not available as an attachable application VHD 616, the disclosed system may proceed to present the user with an error message at operation 706, or the system might encapsulate the application or application image in a VHD 616 to be attached to the computing system.

In one embodiment, at operation 708, the application VHDs 616 including encapsulated files of the selected applications are attached to the computing device 612. As discussed throughout the disclosure herein, VHDs 616 may be attached or mounted to a computing device 612 in such a way that the OS of the computing device 612 does not identity the attached VHD 616 as remote storage. Accordingly, the OS of the computing device 612 may access files stored in the attached VHD 616 just as if the files were stored on a mass storage device local to computing device 612 (e.g. a hard drive, SSD, USB drive, etc.).

At operation 710, the disclosed system may determine if the user at the computing device 612 intends to select more applications, according to one embodiment. In various embodiments, the user need not always determine at logon if he/she needs to attach a particular application as an application VHD 616 (see the discussion below with regard FIG). However, if the disclosed system determines that more applications are to be selected, the exemplary routine 700 may proceed back to operation 702 where the user of the computing device 612 may select from the available applications. In one embodiment, if, at operation 710, the disclosed system determines that no additional applications are to be selected, the current iteration of the exemplary routine 700 may proceed to operation 712, where it ends.

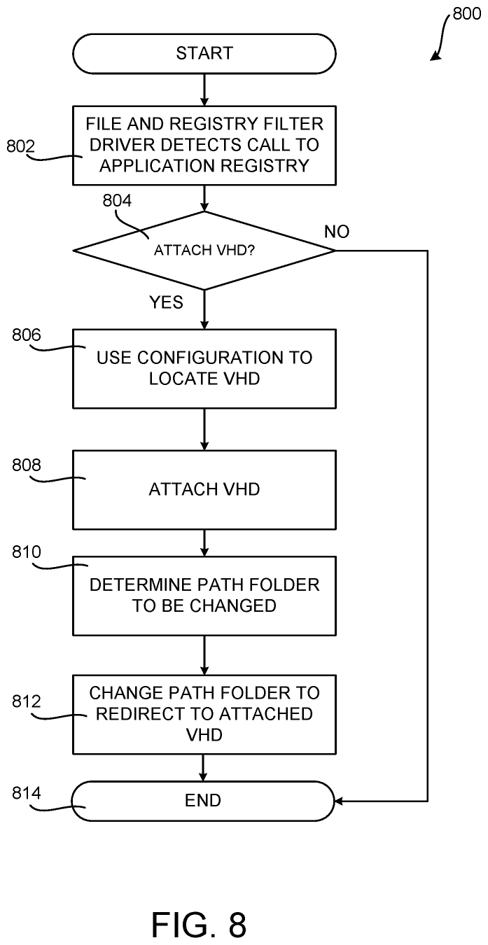

FIG. 8 is a flow diagram showing aspects of an illustrative routine 800 for attaching a VHD 616 to a computing device 612. Similar to the exemplary routine 700 discussed above, the routine 800 provides functionality for attaching application VHDs 616 to a computing device 612 to allow the computing device 612 to access applications in a virtual computing environment without the need to package and sequence applications for virtualization. As will be discussed in greater detail below, the routine 800 leverages the filter driver 118 for detecting registry activity associated with particular applications. Based on particular detected activity, the disclosed system may determine that an application VHD 616 is to be attached to the computing device 612 to support the particular detected registry activity.

The exemplary routine 800 begins at operation 802, where the filter driver 118 detects a call or other activity directed to a registry, according to one embodiment. As is discussed above, the filter driver 118 may monitor input/output (“I/O”) requests, instruction calls, and general registry requests, and furthermore be configured to act based on the detected activity.

According to a particular embodiment, if the filter driver 118 detects activity at an application registry, the routine 800 may proceed to operation 804, where the disclosed system determines if a VHD 616 should be attached to the computing device 612 to support the call to the application registry. For example, the computing device may include a path or registry for MICROSOFT® WORD®, however, the contents of the path may be hidden, masked, or generally not available to the local operating system. Thus, if the user of the computing device requests to open MICROSOFT® WORD®, the filter driver 118 may detect this activity and furthermore determine if a VHD 616 including encapsulated application files (e.g., .DLLs files and the like) should be attached to the computing device 612, thus providing the application files to execute the application despite not being physically connected to the computing device 612.

If, at operation 804, it is determined that an application VHD 616 is not to be attached (e.g., the application is already stored locally, a user does not have permission to access the VHD 616, a VHD 616 is not available, etc.), then the current iteration of the exemplary routine 800 may end at operation 814. In a particular embodiment, if, at operation 804, the disclosed system determines that an application VHD 616 is to be attached, the exemplary routine 800 proceeds to operation 806, where the system uses configuration data to locate the VHD 616 to be attached. In one embodiment, operation 806 is similar to operation 406 discussed above with respect to the exemplary routine 400, such that the system relies on processes such as the configuration routine 500 for determining if the user of the computing device 612 has access rights to a particular application VHD 616 (e.g., if the user is included in an “include group”), and generally which applications or application files to encapsulate within the VHD 616.

At operation 808, the application VHD 616 with encapsulated application files is attached to the computing device 612, according to one embodiment. As is discussed herein, VHDs 616 in general may be attached (or mounted) to computing devices 612 such that the local OS at the computing device 612 is unable to detect the difference between the VHD 616 and a locally connected mass storage device.

According to various aspects of the present disclosure, attaching the application VHD 616 with encapsulated application files at operation 808 provides the computing device 612 with access to a registry hive associated with the application, thereby allowing access to real application files in a virtual environment and bypassing the need to package and sequence applications, such as in conventional systems.

In response to attaching the application VHD 616 to the computing device 612, the routine 800 may proceed to operation 810, where the system determines the storage system path folder to be changed. In various embodiments, the path folder to be changed is the preexisting application path folder on the computing device 612, which may be, for example the “C:\ProgramFiles(x86)\Adobe\AcrobatDC\Acrobat\pdfport.dll” path, or the like.

At operation 812, the system changes the path folder to redirect calls and registry requests originally directed to this path folder to instead be redirected to the application VHD 616 location, or the loaded application registry hive. In particular embodiments, changing the path folder may include simply renaming the folder path to redirect to the application VHD 616, or a temporary folder path may be generated that “hides” the local directory and redirects application calls to a junction that points to the application VHD 616 and encapsulated application files.

In particular embodiments, the system may be configured to direct requests for particular application files to the attached VHD 616 without first redirecting the requests via a junction. For example, the VHD 616 may be attached to the computing system 612 as a letter drive, and the system may be configured to direct registry requests for the particular application to the letter drive of the VHD 616.

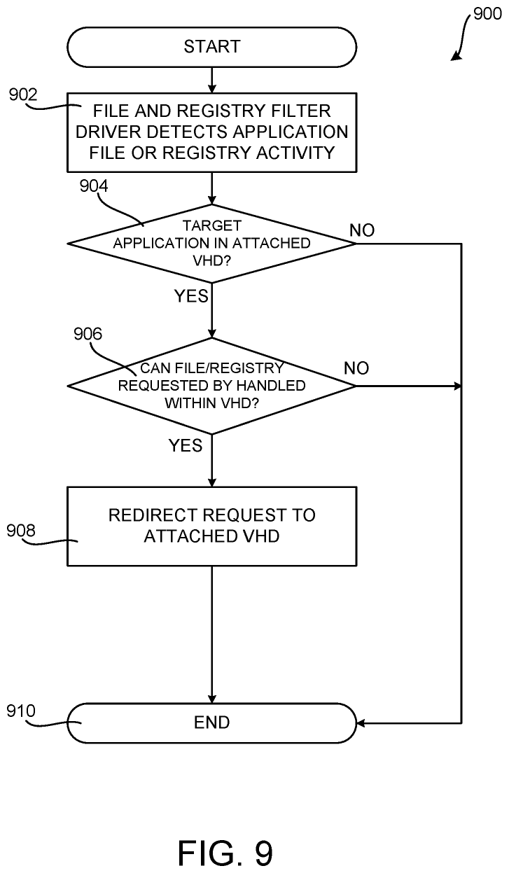

Turning now to FIG. 9, an exemplary redirection routine 900 will be described, according to one embodiment of the present disclosure. The routine 900 begins at operation 902 when the filter driver 118 detects application file or registry activity, according to various embodiments. In one embodiment, and as discussed throughout the disclosure herein, the filter driver 118 and associated service(s) may be configured to monitor I/O, instruction calls, and general registry activity within the system.

In a particular embodiment, and in response to attaching application VHDs 616 to the computing device 612, the filter driver 118 may monitor activity specifically for the applications encapsulated within the VHDs 616. For example, filter driver 118 may detect a request from the user to launch MICROSOFT® WORD®. In scenarios without a filter driver 118 and attached application VHDs 616, a request to launch an application may execute locally, and a .EXE or .DLL file may launch for initiating MICROSOFT® WORD®. However, according to various aspects of the present disclosure, the system described herein may redirect the detected request to an attached application VHD 616 for accomplishing the same.

At operation 904, in particular embodiments, the system determines if the target application is included in an attached VHD 616. In one embodiment, the system may query and search attached VHDs 616 just as it would search a local computer file system or registry. Accordingly, because the filter driver 118 detected activity that is known to be associated with an attached VHD 616, the system may search the attached VHDs 616 for the particular application VHD rather than searching a local file system/registry. In some embodiments, if the target application is not included in an attached VHD 616, the current iteration of the routine 900 may end at operation 910, or the system may attach an application VHD 616 to accommodate the detected registry activity (operation not shown in FIG. 9).

In particular embodiments, at operation 906 the system determines if the detected file or registry activity can be handled using the contents of the VHD 616. For example, the application VHD 616 might only include a portion of the application files (e.g. for increased performance and reduced storage requirements) and, as a result, file or registry activity may be detected that cannot be handled using the current instance of the application VHD 616. In these scenarios, the routine 900 may end at operation 910, the system may attach an application VHD 616 for handling the detected activity (operation not shown in FIG. 9), or the system may redirect the application activity to a separate location (such as a remote server) for handling the detected registry activity. However, if at operation 906 it is determined that the detected registry activity can be handled by the attached application VHD 616 (e.g., the application VHD includes the necessary .DLL or .EXE files), the routine 900 may proceed to operation 908.

In one embodiment, at operation 908, the detected file or registry request (or any appropriate request or registry activity) is redirected to the attached application VHD 616, where the resources for the request are located. In various embodiments, the detected registry activity may be handled at the application VHD 616 (e.g., the request file is run and the output is returned to the computing device 612), or resources from the application VHD 616 may be transmitted to the computing device 612 to be processed locally (e.g., the system retrieves particular .DLL or .EXE files to execute the application).

Referring now to FIG. 10, an exemplary image preparation routine 1000 will be described, according to one aspect of the present disclosure. As mentioned herein, an OS image may be encapsulated within an attached VHD 616 for providing application files to a computing device 612, such that file and registry requests may be directed to the VHD 616 rather than a local destination. In this way, the application is available to the computing device 612 in a virtual environment without the need for packaging/sequencing because the application is operating within an environment that is proven to be compatible with the computing device 612 (e.g., the OS image).

In one embodiment, the exemplary routine 1000 begins at operation 1002, where the system clones an OS image, such as an image of the MICROSOFT WINDOWS operating system. In various embodiments, the OS image is an image of a physical disk, such as a disk of a computer, where the disk includes one or more applications, settings, user accounts, etc., for providing an operable computing environment. In some embodiments, the image may be cloned from a physical disk, or the image may be cloned from a previously cloned virtual disk.

In one embodiment, at operation 1004 of the exemplary routine 1000, the user (or system admin) may select an application included within the OS image to be encapsulated within a VHD 616. For example, the OS image may include a plurality of applications, but the user may select MICROSOFT® WORD® as the application to be included within the encapsulated VHD 616. According to various aspects of the present disclosure, the selected application stored in the OS image is already configured to run on the computing device 612, and thus no packaging or sequencing of the application is needed.

In various embodiments, at operation 1006, non-essential files are removed from the OS image. In one embodiment, at operation 1006, the system generates the smallest possible OS image that is bootable and/or runs the selected application. In particular embodiments, files such as C:\users files, docs and settings, drivers (e.g., printers, Bluetooth, etc.), other program files, etc., are removed from the image. Stripping non-essential files from the OS image allows for an application to operate within a virtual environment that is known to be compatible with a computing device 612, avoids the complications of sequencing/packaging, and provides an image that is substantially smaller in size than a standard disk image (for enhanced performance).

In some embodiments, the system may implement machine learning (“ML”) techniques for determining, at runtime, which files should be stripped from the OS image. For example, the system may determine, via ML techniques, that the least recently accessed files from the OS image should be removed. According to various aspects of the present disclosure, implementing ML techniques allows for the disclosed system to identify non-essential files to remove that otherwise may not have been removed, thus allowing for the system to generate an overall smaller image (which may or may not be bootable) to be encapsulated within a VHD 616.

Various ML techniques can be utilized to provide the functionality described above. For example, ML models for identifying files to be removed from an OS image can be trained be trained using supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc. Other ML techniques can be utilized in other embodiments.

At operation 1006, in one embodiment, the reduced or stripped OS image is encapsulated within a VHD 616. In various embodiments, the reduced OS image includes only the essential files for booting the image in a virtual environment and/or the files for running a selected application. According to various aspects of the present disclosure, the reduced OS image is encapsulated within a VHD 616 for attaching or mounting the VHD to a computing device 616, thereby allowing for the computing device 612 to access the encapsulated application files and thus run the application using files stored on the VHD 616.

In particular embodiments, the reduced size OS images may be encapsulated prior to logon, at logon, or the images may be encapsulated during runtime. In various embodiments, determining when to encapsulate a reduced size OS image is a performance decision, and it may be determined to encapsulate the images at prior to logon, at logon, during runtime, or at a combination of times. The ML techniques described above might also be leveraged to determine when to encapsulate images within VHDs 616, and also when to attach VHDs 616 to the computing system 612.

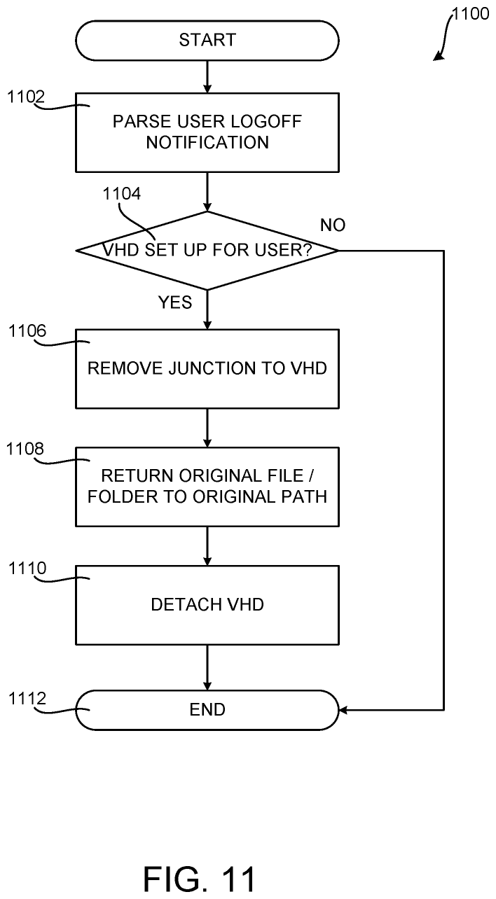

Referring now to FIG. 11, a routine 1100 will be described that illustrates aspects of an exemplary user logoff process. Generally, the exemplary user logoff process is a process by which the service 130 detaches the VHD 618 (that was attached as part of the exemplary user logon process described above with regard to FIG. 4 or the exemplary processes described with reference to FIGS. 7 and 8) and restores the original files/folders to their original file paths (that were changed from their original file paths as part of the exemplary user logon process described above with regard to FIG. 4 or the process described with reference to FIG. 8).

The routine 1100 begins operation 1102, where the service 130 parses a user logoff notification to retrieve the user identification corresponding to the user that is currently logging off of the OS. Generally, the service 130 may extract other data from the logon notification at operation 1102 as appropriate (e.g., time and date information for analytics purposes, etc.). In one embodiment, the service 130 does not implement operation 1102 as it is already aware of the user's identity from the exemplary user logon process described above.

In various embodiments, the service 130 may use the data extracted/parsed from the user logoff notification to determine, at operation 1104, whether a VHD 618 has been set up for the identified user. In one embodiment, the service 130 may, at operation 1104, run diagnostics on the OS and/or computing device to determine whether a VHD 618 is currently attached to the same.

If a VHD 618 is not attached then, in one embodiment, the exemplary user logoff routine 1100 proceeds from operation 1104 to operation 1112, where it ends. If, however, a VHD 618 is attached, then, in one embodiment, at operation 1106, the service 130 removes the junction point (generated at operation 418 in FIG. 4) to the VHD 618 so that the software program and/or OS can no longer access the VHD 618 and the files/folders encapsulated thereon as if they were the original file/folders.

After removing the junction point, in various embodiments, at operation 1108, the service 130 returns the original file/folder to its original file path (which was modified at operation 416 in FIG. 4) so that the OS/software program may access the original file/folders. In various embodiments, the service 130 detaches the VHD 618 at operation 1110 so that it is no longer accessible to the computing device. After detaching the VHD 618 at operation 1110, the routine 1100 proceeds to operation 1112, where it ends.

Operating Environment

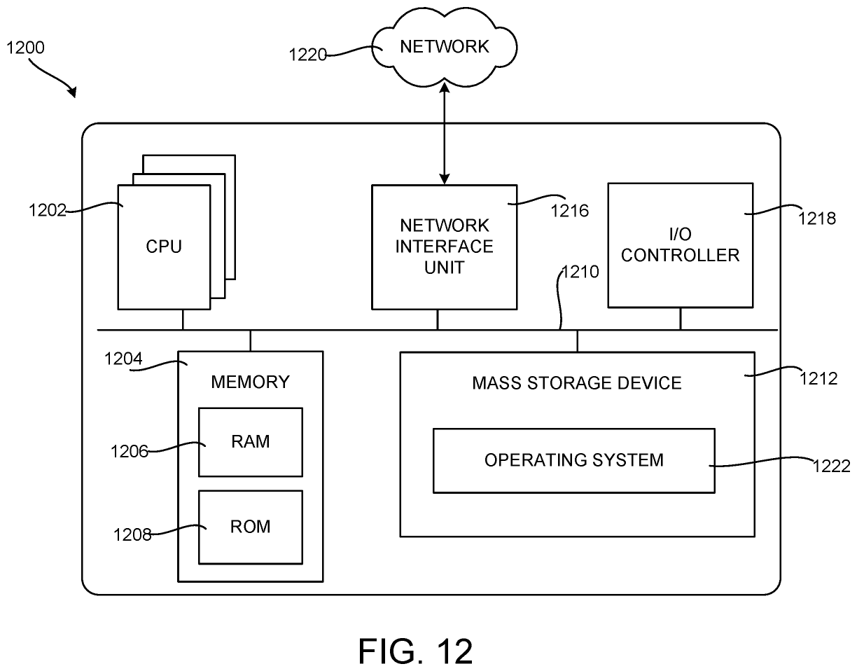

FIG. 12 is a computer architecture diagram showing an illustrative computer hardware and software architecture for a computing device that can implement the various technologies presented herein. In particular, the architecture illustrated in FIG. 12 can be utilized to implement a server computer, mobile phone, an e-reader, a smartphone, a desktop computer, an AR/VR device, a tablet computer, a laptop computer, or another type of computing device.

The computer 1200 illustrated in FIG. 12 includes a central processing unit 1202 (“CPU”), a system memory 1204, including a random-access memory 1206 (“RAM”) and a read-only memory (“ROM”) 1208, and a system bus 1210 that couples the memory 1204 to the CPU 1202. A basic input/output system (“BIOS” or “firmware”) containing the basic routines that help to transfer information between elements within the computer 1200, such as during startup, can be stored in the ROM 1208. The computer 1200 further includes a mass storage device 1212 for storing an OS 1222, such as a WINDOWS NT-based OS, application programs, and other types of programs. The mass storage device 1212 can also be configured to store other types of programs and data.

The mass storage device 1212 is connected to the CPU 1202 through a mass storage controller (not shown) connected to the bus 1210. The mass storage device 1212 and its associated computer readable media provide non-volatile storage for the computer 1200. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 1200.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 1200. For purposes of the claims, the phrase “computer storage medium,” and variations thereof, does not include waves or signals per se or communication media.

According to various configurations, the computer 1200 can operate in a networked environment using logical connections to remote computers through a network such as the network 1220. The computer 1200 can connect to the network 1220 through a network interface unit 1216 connected to the bus 1210. It should be appreciated that the network interface unit 1216 can also be utilized to connect to other types of networks and remote computer systems. The computer 1200 can also include an input/output controller 1218 for receiving and processing input from a number of other devices, including a keyboard, mouse, touch input, an electronic stylus (not shown in FIG. 12), or a physical sensor such as a video camera. Similarly, the input/output controller 1218 can provide output to a display screen or other type of output device (also not shown in FIG. 12).

It should be appreciated that the software components described herein, when loaded into the CPU 1202 and executed, can transform the CPU 1202 and the overall computer 1200 from a general-purpose computing device into a special-purpose computing device customized to facilitate the functionality presented herein. The CPU 1202 can be constructed from any number of transistors or other discrete circuit elements, which can individually or collectively assume any number of states. More specifically, the CPU 1202 can operate as a finite-state machine, in response to executable instructions contained within the software modules disclosed herein. These computer-executable instructions can transform the CPU 1202 by specifying how the CPU 1202 transitions between states, thereby transforming the transistors or other discrete hardware elements constituting the CPU 1202.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 1200 in order to store and execute the software components presented herein. It also should be appreciated that the architecture shown in FIG. 12 for the computer 1200, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 1200 might not include all of the components shown in FIG. 12, can include other components that are not explicitly shown in FIG. 12, or can utilize an architecture completely different than that shown in FIG. 12.

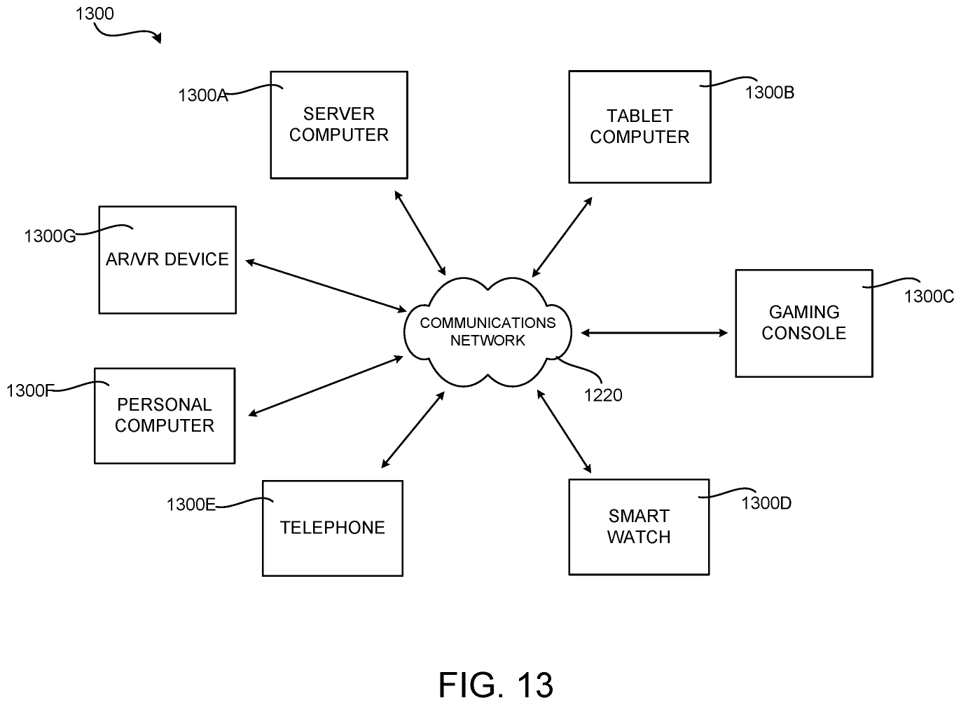

FIG. 13 is a network diagram illustrating a distributed network computing environment 1300 in which aspects of the disclosed technologies can be implemented, according to various embodiments presented herein. As shown in FIG. 13, one or more server computers 1300A can be interconnected via a communications network 1220 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as, but not limited to, a tablet computer 1300B, a gaming console 1300C, a smart watch 1300D, a telephone 1300E, such as a smartphone, a personal computer 1300F, and an AR/VR device 1300G.

In a network environment in which the communications network 1220 is the Internet, for example, the server computer 1300A can be a dedicated server computer operable to process and communicate data to and from the client computing devices 1300B-1300G via any of a number of known protocols, such as, hypertext transfer protocol (“HTTP”), file transfer protocol (“FTP”), or simple object access protocol (“SOAP”). Additionally, the networked computing environment 1300 can utilize various data security protocols such as secured socket layer (“SSL”) or pretty good privacy (“PGP”). Each of the client computing devices 1300B-1300G can be equipped with an OS operable to support one or more computing applications or terminal sessions such as a web browser (not shown in FIG. 13), or other graphical user interface (not shown in FIG. 13), or a mobile desktop environment (not shown in FIG. 13) to gain access to the server computer 1300A.

The server computer 1300A can be communicatively coupled to other computing environments (not shown in FIG. 13) and receive data regarding a participating user's interactions/resource network. In an illustrative operation, a user (not shown in FIG. 13) may interact with a computing application running on a client computing device 1300B-1300G to obtain desired data and/or perform other computing applications.

The data and/or computing applications may be stored on the server 1300A, or servers 1300A, and communicated to cooperating users through the client computing devices 1300B-1300G over an exemplary communications network 1220. A participating user (not shown in FIG. 13) may request access to specific data and applications housed in whole or in part on the server computer 12800A. These data may be communicated between the client computing devices 1300B-1300G and the server computer 1300A for processing and storage.

The server computer 1300A can host computing applications, processes and applets for the generation, authentication, encryption, and communication of data and applications, and may cooperate with other server computing environments (not shown in FIG. 13), third party service providers (not shown in FIG. 13), network attached storage (“NAS”) and storage area networks (“SAN”) to realize application/data transactions.

It should be appreciated that the computing architecture shown in FIG. 12 and the distributed network computing environment shown in FIG. 13 have been simplified for ease of discussion. It should also be appreciated that the computing architecture and the distributed computing network can include and utilize many more computing components, devices, software programs, networking devices, and other components not specifically described herein.

The disclosure presented herein also encompasses the subject matter set forth in the following clauses:

Clause 1. A computer-implemented method performed by a computing device, the method comprising: attaching a virtual hard drive (VHD) to the computing device; intercepting a request for a file of an application stored on the VHD; responsive to intercepting the request for the file, redirecting the request for the file to the VHD; intercepting a request to access a registry stored at the computing device; and responsive to intercepting the request to access the registry stored at the computing device, redirecting the request to access the registry stored at the computing device to a registry stored in the VHD.

Clause 2. The computer-implemented method of clause 1, wherein the request for the file is intercepted by a filter driver executing on the computing device and wherein the filter driver is configured to redirect the request for the file to the VHD.

Clause 3. The computer-implemented method of any of clauses 1 or 2, wherein the request to access the registry stored at the computing device is intercepted by a filter driver executing on the computing device and wherein the filter driver is configured to redirect the request to access the registry stored at the computing device to the registry stored in the VHD.

Clause 4. The computer-implemented method of any of clauses 1-3, wherein redirecting the request to access the registry stored at the computing device to a registry stored in the VHD comprises redirecting the request to access the registry to a registry hive retrieved from the VHD.

Clause 5. The computer-implemented method of any of clauses 1-4, wherein the registry hive is retrieved from the VHD in response to intercepting the request from the application to access the registry stored at the computing device.

Clause 6. The computer-implemented method of any of clauses 1-5, wherein the request for the file is intercepted by changing a path of a location of the file on a file system local to the computing device such that the location is inaccessible and associating a junction point with the location of the file on the file system, the junction point defining a location of the file on the VHD.

Clause 7. The computer-implemented method of any of clauses 1-6, wherein the VHD is stored local to the computing device.

Clause 8. The computer-implemented method of any of clauses 1-7, wherein the VHD is stored at network-accessible location.

Clause 9. A computing device, comprising: a processor; and a non-transitory computer-readable storage medium having executable instructions stored thereupon which, when executed by the processor, cause the computing device to: attach a virtual hard drive (VHD) to the computing device such that the VHD appears local to the computing device, the VHD storing files associated with an application; execute a filter driver, the filter driver configured to intercept a request from the application for one of the files associated with the application stored on the VHD; responsive to intercepting the request for the file at the filter driver, redirect the request for the file to the VHD; intercept, by way of the filter driver, a request from the application to access a registry stored at the computing device; and responsive to intercepting the request to access the registry stored at the computing device, redirect the request to access the registry stored at the computing device to a registry stored in the VHD.

Clause 10. The computing device of clause 9, wherein redirect the request to access the registry stored at the computing device to a registry stored in the VHD comprises redirecting the request to access the registry to a registry hive retrieved from the VHD.

Clause 11. The computing device of any of clauses 9 or 10, wherein the registry hive is retrieved from the VHD in response to intercepting the request from the application to access the registry stored at the computing device.

Clause 12. The computing device of any of clauses 9-11, wherein the request for the file is intercepted by changing a path of a location of the file on a file system local to the computing device such that the location is inaccessible and associating a junction point with the location of the file on the file system, the junction point defining a location of the file on the VHD.

Clause 13. The computing device of any of clauses 9-12, wherein the VHD is stored local to the computing device.

Clause 14. The computing device of any of clauses 9-13, wherein the VHD is stored at a network-accessible location.

Clause 15. The computing device of any of clauses 9-14, wherein one or more files not required for executing the application are removed from the VHD prior to attaching the VHD to the computing device.

Clause 16. A non-transitory computer-readable storage medium having computer-executable instructions stored thereupon which, when executed by a computing device, cause the computing device to: execute a filter driver, the filter driver configured to intercept a request from an application for a file associated with the application; responsive to intercepting the request for the file at the filter driver, redirect the request for the file to a virtual hard drive (VHD); intercept, by way of the filter driver, a request from the application to access a registry stored at the computing device; and responsive to intercepting the request to access the registry stored at the computing device, redirect the request to access the registry stored at the computing device to a registry stored in the VHD.

Clause 17. The non-transitory computer-readable storage medium of clause 16, wherein redirect the request to access the registry stored at the computing device to a registry stored in the VHD comprises redirecting the request to access the registry to a registry hive retrieved from the VHD.

Clause 18. The non-transitory computer-readable storage medium of any of clauses 16 or 17, wherein the registry hive is retrieved from the VHD in response to intercepting the request from the application to access the registry stored at the computing device.

Clause 19. The non-transitory computer-readable storage medium of any of clauses 16-18, wherein the request for the file is intercepted by changing a path of a location of the file on a file system local to the computing device such that the location is inaccessible and associating a junction point with the location of the file on the file system, the junction point defining a location of the file on the VHD.

Clause 20. The non-transitory computer-readable storage medium of any of clauses 16-19, wherein the VHD is stored at a network-accessible location.

Conclusion

Based on the foregoing, it should be appreciated that technologies for providing remote application access in a VDI environment have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

Many modifications and other embodiments of the technologies disclosed herein may come to mind to one skilled in the art to which this invention pertains having the benefit of the teachings presented in the foregoing descriptions and the associated drawings. While several examples discussed above are illustrated with regard to a MICROSOFT OUTLOOK data file, ADOBE® dynamically linked libraries, application files, operating system images, and with regard to a WINDOWS NT-based OS, the technologies described herein may be used in any other suitable context. Therefore, it is to be understood that the technologies described herein are not to be limited to the specific embodiments disclosed and that modifications and other embodiments are intended to be included within the scope of the appended claims. Although specific terms are employed herein, they are used in a generic and descriptive sense only and not for the purposes of limitation.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method performed by a computing device, the method comprising:
attaching a virtual hard drive (VHD) to the computing device;
intercepting a request for a file of an application stored on the VHD;
responsive to intercepting the request for the file, redirecting the request for the file to the VHD;
intercepting a request to access a registry stored at the computing device; and
responsive to intercepting the request to access the registry stored at the computing device, redirecting the request to access the registry stored at the computing device to a registry stored in the VHD.

2. The computer-implemented method of claim 1, wherein the request for the file is intercepted by a filter driver executing on the computing device and wherein the filter driver is configured to redirect the request for the file to the VHD.

3. The computer-implemented method of claim 1, wherein the request to access the registry stored at the computing device is intercepted by a filter driver executing on the computing device and wherein the filter driver is configured to redirect the request to access the registry stored at the computing device to the registry stored in the VHD.

4. The computer-implemented method of claim 1, wherein redirecting the request to access the registry stored at the computing device to a registry stored in the VHD comprises redirecting the request to access the registry to a registry hive retrieved from the VHD.

5. The computer-implemented method of claim 4, wherein the registry hive is retrieved from the VHD in response to intercepting the request from the application to access the registry stored at the computing device.

6. The computer-implemented method of claim 1, wherein the request for the file is intercepted by changing a path of a location of the file on a file system local to the computing device such that the location is inaccessible and associating a junction point with the location of the file on the file system, the junction point defining a location of the file on the VHD.

7. The computer-implemented method of claim 1, wherein the VHD is stored local to the computing device.

8. The computer-implemented method of claim 1, wherein the VHD is stored at network-accessible location.

9. A computing device, comprising:
a processor; and
a non-transitory computer-readable storage medium having executable instructions stored thereupon which, when executed by the processor, cause the computing device to:
attach a virtual hard drive (VHD) to the computing device such that the VHD appears local to the computing device, the VHD storing files associated with an application;
execute a filter driver, the filter driver configured to intercept a request from the application for one of the files associated with the application stored on the VHD;
responsive to intercepting the request for the file at the filter driver, redirect the request for the file to the VHD;
intercept, by way of the filter driver, a request from the application to access a registry stored at the computing device; and
responsive to intercepting the request to access the registry stored at the computing device, redirect the request to access the registry stored at the computing device to a registry stored in the VHD.

10. The computing device of claim 9, wherein redirect the request to access the registry stored at the computing device to a registry stored in the VHD comprises redirecting the request to access the registry to a registry hive retrieved from the VHD.

11. The computing device of claim 10, wherein the registry hive is retrieved from the VHD in response to intercepting the request from the application to access the registry stored at the computing device.

12. The computing device of claim 9, wherein the request for the file is intercepted by changing a path of a location of the file on a file system local to the computing device such that the location is inaccessible and associating a junction point with the location of the file on the file system, the junction point defining a location of the file on the VHD.

13. The computing device of claim 9, wherein the VHD is stored local to the computing device.

14. The computing device of claim 9, wherein the VHD is stored at a network-accessible location.

15. The computing device of claim 9, wherein one or more files not required for executing the application are removed from the VHD prior to attaching the VHD to the computing device.

16. A non-transitory computer-readable storage medium having computer-executable instructions stored thereupon which, when executed by a computing device, cause the computing device to:
execute a filter driver, the filter driver configured to intercept a request from an application for a file associated with the application;
responsive to intercepting the request for the file at the filter driver, redirect the request for the file to a virtual hard drive (VHD);
intercept, by way of the filter driver, a request from the application to access a registry stored at the computing device; and
responsive to intercepting the request to access the registry stored at the computing device, redirect the request to access the registry stored at the computing device to a registry stored in the VHD.

17. The non-transitory computer-readable storage medium of claim 16, wherein redirect the request to access the registry stored at the computing device to a registry stored in the VHD comprises redirecting the request to access the registry to a registry hive retrieved from the VHD.

18. The non-transitory computer-readable storage medium of claim 17, wherein the registry hive is retrieved from the VHD in response to intercepting the request from the application to access the registry stored at the computing device.

19. The non-transitory computer-readable storage medium of claim 16, wherein the request for the file is intercepted by changing a path of a location of the file on a file system local to the computing device such that the location is inaccessible and associating a junction point with the location of the file on the file system, the junction point defining a location of the file on the VHD.

20. The non-transitory computer-readable storage medium of claim 16, wherein the VHD is stored at a network-accessible location.
